(19) United States
(12) Patent Application Publication
(10) Pub. No.: US 2002/0187679 A1
(43) Pub. Date: Dec. 12, 2002

(54) Electrical connector with metallized polymeric housing

(76) Inventor: Stanley W. Olson, East Berlin, PA (US)

Correspondence Address: HARRINGTON & SMITH, LLP, 4 RESEARCH DRIVE, SHELTON, CT, 06484-6212, US

(21) Appl. No.: 09/879,481

(22) Filed: Jun. 12, 2001

(51) Int. Cl. H01R 13/648

(52) U.S. Cl. 439/608

(57) ABSTRACT

An electrical connector is provided. The electrical connector has a housing. Signal contacts are secured to the housing and ground contacts are secured to the housing. A portion of the housing is metallized to connect the ground contacts electrically and to shield the signal contacts.

### BACKGROUND OF THE INVENTION

This disclosure relates to backpanel connector systems, structures and methods for providing closer control of connector impedance and cross talk among high frequency communication signals carried over densely packed signal lines.

More specifically, the present disclosure relates to the use of grounded conductive paths to shield adjacent signals, or differential signal pairs, from one another at the backplane of, for example, a switch, a router, access server and other network communication system devices involved with transferring voice, video and other forms of data at gegabit per second (Gb/s) and higher data rates between user and provider sites.

The increasingly stringent requirements for higher system bandwidth necessitate closer control of connector impedance and suppression of crosstalk to preserve the integrity of network information. These requirements have been met earlier with strategically positioned stamped and formed metal ground shields that separate single signal communication lines, or differential signal line pairs, from other signal lines/line pairs and provide a return path to ground. An example of such ground shields is in U.S. Pat. No. 6,116,926. However, these spaced ground shields can be cumbersome, expensive and, more importantly, may not provide adequate shielding and grounding for future systems having substantially higher line densities and carrying signals at substantially higher data rates. An example of an earlier developed backpanel connector using the aforementioned metal ground shielding includes the METRAL® 3000 Series 2 mm backpanel connector systems available from FCI USA, Inc. Information about a METPAL® 3000 connector is available from FCI USA, Inc. in a brochure identified by part number 950534-008 and dated Aug. 8, 2000. Another earlier development of connectors using metallized plastic connector housings includes a shielded connector disclosed in U.S. Pat. No. 5,228,871.

The shortcomings of earlier developed connectors employing multiple, metal conductive shields to electrically isolate single data signal lines or differential pair data signal lines from other single lines or differential pairs of lines are overcome with the new and improved connector disclosed herein.

### SUMMARY OF THE INVENTION

In accordance with one embodiment of the present invention, an electrical connector is provided. The electrical connector has a housing. Signal contacts and ground contacts are secured to the housing. A portion of the housing is metallized to connect the ground contacts electrically and to shield the signal contacts.

In accordance with another embodiment of the present invention, a backplane receptacle connector is provided. The backplane receptacle connector has an exterior housing. A plurality of sub-assemblies are arranged within the exterior housing. Each sub-assembly has a housing. Signal contacts and ground contacts are secured to the housing. A portion of each of the housings are metallized to connect the ground contacts electrically and to shield the signal contacts.

In accordance with a method of the present invention, a method of shielding a connector is provided having a first step of providing a housing with contacts secured thereto. Another step of metallizing a portion of the housing to connect the contacts electrically is then provided.

### BRIEF DESCRIPTION OF THE DRAWINGS

The foregoing aspects and other features of the present invention are further disclosed in the following description considered alone and in conjunction with the accompanying drawings, wherein:

FIG. 1 is a schematic diagram of a connector system incorporating features of the present invention.

FIG. 2a is an external view of a sub-assembly housing of the connector in FIG. 1.

FIG. 2b is a top plan view of a sub-assembly housing.

FIG. 2c is a front side elevation view of a sub-assembly housing.

FIG. 3a is an external view of a second embodiment sub-assembly housing.

FIG. 3b is a top plan view of the second embodiment sub-assembly housing.

FIG. 4 is a front elevation view of the second embodiment sub-assembly housing.

### DESCRIPTION OF THE EMBODIMENTS

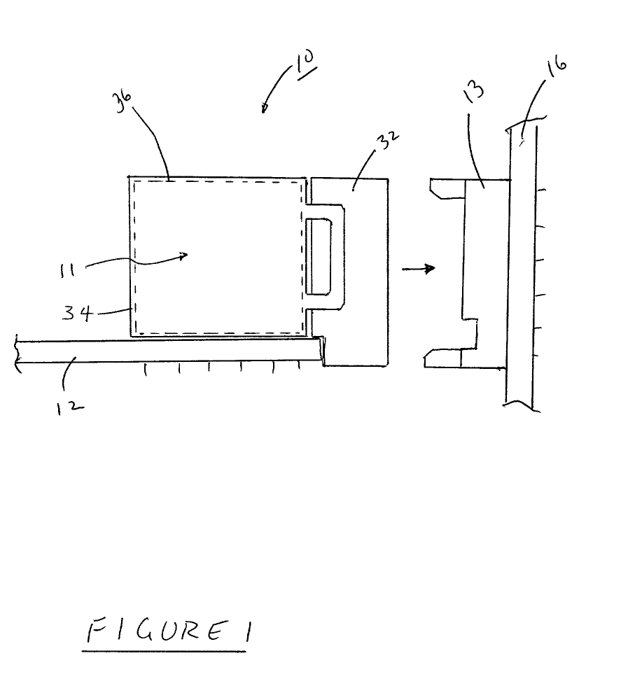

The system 10 of FIG. 1 represents a combination of four components that make up a portion of a digital signal communication network within which the present invention is employed. Although the present invention will be described with reference to the embodiments shown in the drawings, it should be understood that the present invention can be embodied in many alternate forms or embodiments. In addition, any suitable size, shape or type of elements or materials could be used. The components of system 10 include receptacle connector 11. Connector 11 is built from sub-assemblies which provide multiple, low-impedance, electrically shielded signal paths for gigabit per second (Gb/s) and higher network data signal transmission. The receptacle 11 mounts to a daughter card 12, for example a network telephone subscriber line card. The receptacle 11 mates with a header connector 13 secured to a compatible backpanel 16, such as a network data switch.

Receptacle 11 includes a forward external housing 32 and a rear external housing 34. The housings secure together to retain a plurality of subassemblies 36 (shown in phantom for clarity) therebetween. Each sub-assembly includes signal and ground contacts to engage corresponding pins on the header 13. The sub-assembly will be described in more detail below.

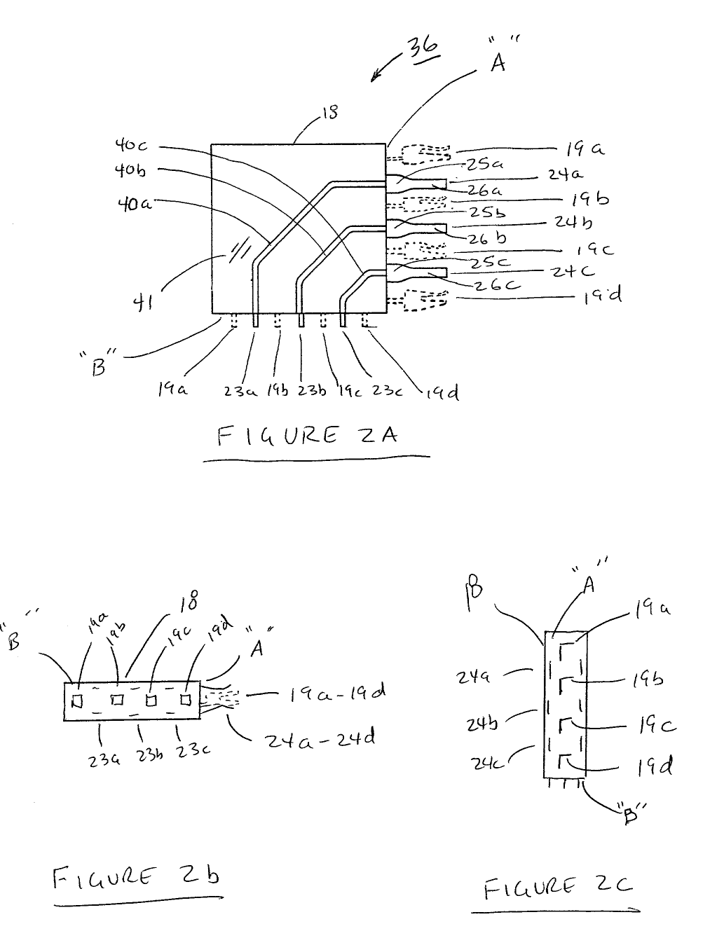

FIGS. 2a, 2b and 2c disclose one embodiment of receptacle connector sub-assembly with one column of signal contacts.

The sub-assembly 36 of FIG. 2a has an insulative housing 18 through which data signal contacts 19a, 19b, 19c and 19d extend (signal contacts are shown in phantom for clarity). The signal contacts have a female mating section at housing face “A” to engage a header pin and a male mounting section at housing face “B” to secure receptacle 11 to board 12. Preferably, housing 18 is overmolded about contacts 19a-19d.

The exterior of housing 18 includes a series of grooves 40a-40c in the sidewalls (see FIG. 2a). The grooves 40a-40c can be formed when the housing is overmolded about the signal contacts 19a-19d. Specifically, the grooves are located between two adjacent signal contacts. As will become evident below, the grooves are beneficial during metallization of housing 18.

The sub-assembly 36 also includes grounding features. Specifically, the sub-assembly includes mating contacts 24a-24c and mounting contacts 23a-23c. These ground contacts are preferably inserted into the housing 18 in a process known as staking. However, the housing 18 could be overmolded about these ground contacts along with mating contacts 24a-24c. These contacts extend from the end faces “A”, “B” of housing 18 adjacent the bottom of the grooves 40a-40c. To make the electrical connection between mating contacts 24a-24c and mounting contacts 23a-c, selected portions of the housing are then metallized. Preferably, the entire exterior of housing 18, save the locations from which signal contacts 19a-19dc extend, are metallized with conductive metallization 41. The exterior surfaces are metallized using any suitable process such as, for example, electroless plating, electrolytic plating, sputtering and vacuum metallization.

FIG. 2b depicts dual beam signal contacts 19a-19d. The beams are mechanically biased to apply a contact force to the header signal pins. The dual beam contact helps maintain an electrical connection between two connectors after multiple insertions and withdrawals over time and over multiple temperature cycles.

The receptacle ground contacts 24a-24c mate with male pins from header 13 of FIG. 1, for example. The contacts 24a-24c each include a single beam to engage the header pin. The resiliently flexible ground contacts 24a-24c are tapered to provide a normal force adequate to maintain contact with the header pins over repeated cycles of insertion and withdrawal over time and over wide temperature cycles and to protect the metallization layers.

FIG. 2c is a front view of side “A” of the sub-assembly that includes a row of four female receptacle contacts 19a, 19b, 19c and 19d and three ground contacts 24a, 24b and 24c. Each grounding contact 24a-24c within a single column is located between two corresponding receptacle contacts 19a-19b, 19b-19c, 19c-19d.

Although FIGS. 2a-2c show a pin-in-paste (PIP) type termination to board 12, other terminations, for example, press-fit, surface mount or otherwise could be used.

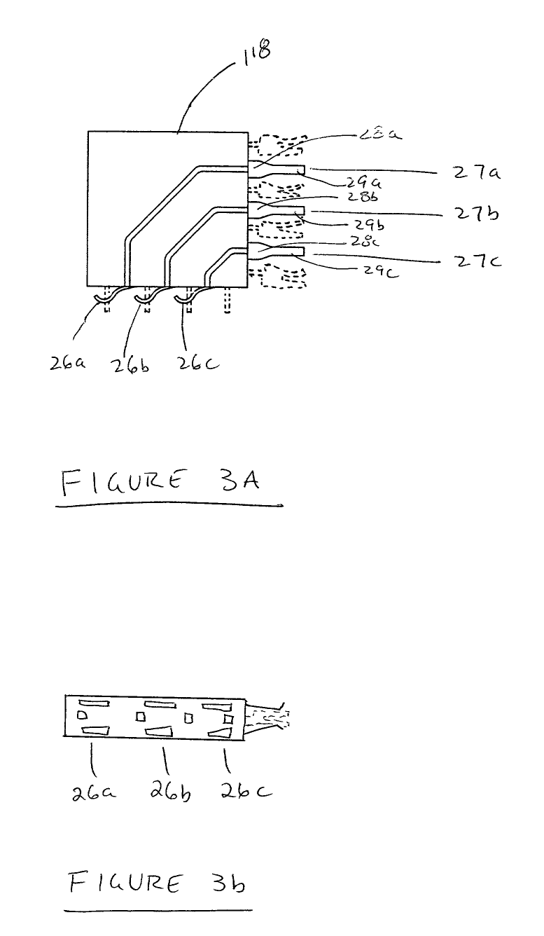

Referring now to FIGS. 3a-3b, there is shown a second embodiment of the present invention. The structure of housing 118 is substantially the same as housing 18 shown in FIGS. 2a-2c. One difference is that spring connectors 26a-26c are used as ground terminals rather than pin terminals. (See, FIGS. 3a and 3b.).

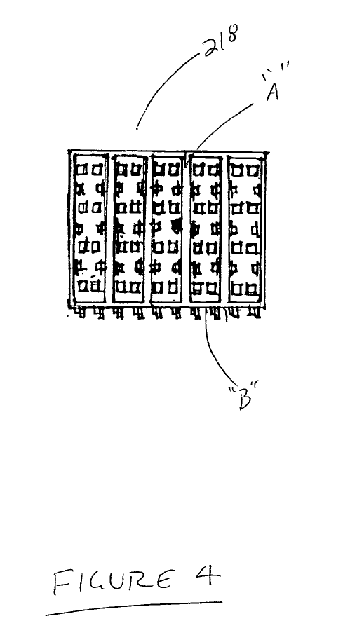

FIG. 4 is a front, elevational view of a third alternative embodiment of the sub-assembly. The general structure of housing 218 is substantially the same as the housings for the first and second embodiments described previously. Rather than the single-ended arrangement of the first and second embodiments, however, housing 218 is wider to accommodate two columns of signal contacts in a differential pair arrangement.

As stated above, selected exterior surfaces of the housing are metallized. Various processes including electroless, electrolytic plating, sputtering and vacuum metallization, for example, could be used.

In order to metallize only certain portions of the housing, a mask (not shown) may be used to protect the remaining portions of the housing, along with the signal contacts 19a-19d. The mask should hide only a portion of the ground contacts 23a-23c, 24a-24c. In other words, a section of each ground contact 23a-23c, 24a-24c is exposed to metallization. Thus, the coating formed by metallization electrically connects ground contacts 23a to 24a, 23b to 24b and 23c to 24c.

The metallization also enters the grooves on the housing. Metallization of the grooves serves to introduce a ground shield between two adjacent signal contacts in a column. The remainder of the metallization serves as a ground shield between adjacent columns of signal contacts. Such shielding helps reduce cross-talk between the signal lines.

Rather than directly engage the metallized layer, the ground contacts on the header mate with the resilient ground contacts on the receptacle. Since the receptacle ground contacts are also partially metallized, the shape of the contact is controlled to prevent damage to the metallized layer. As can be seen in FIGS. 2a, 3a the preferred shape of the receptacle ground contacts 24a-24c and 27a-27c is a wide proximal base 25a-25c and 28a-28c adjacent the housing 18, 118 and a narrower distal end 26a-26c and 29a-29c away from the housing to engage the header pin or the PCB. Preferably, metallization occurs at the wider proximal end of the ground contacts.

The narrower distal end deflects upon engaging the header pin or the PCB. Such deflection, however, is not observed in the wider proximal end. Without deflection, the metallized layer located on the wider proximal end is unaffected by the mating cycles.

When the sub-assemblies are mounted side to side within the outer housings, the arrangement creates a mechanically and electrically stable structure able to electrically shield large numbers of data signal lines or differential pairs operating at Gb/s data rates and higher.

The electrical shielding of a single data signal line or data signal differential line pair is achieved by:

(1) electrically coupling each ground 23a-23c, 24a-24c to a metallized layer shown on housing 18 at 41 or coating on the housing, and

(2) coupling the ground contacts 23a, 23b and 23c and 24a, 24b and 24c, respectively, to the ground plane of a subscriber line card 12, for example, and to the ground plane of a back panel 16, through header 13 for example; and

The minimization or elimination of movement at the interface of a connector 11 to a printed wiring board (PWB) such as the PWB of the line card 12 ensures that continuity will be maintained through a number of deflections cycles. The spring members 23a-23c or 26a-26c at the base of the sub-assembly bring continuity to the ground plane on PWB 12 to which a connector 11 is mounted. The same minimization of movement is achieved by the wider proximal end of contacts 24a-24c or 27a-27c.

When a multiple-column embodiment of connector 11 is mounted to a PWB, the metalized housing and pins are terminated to the PWB via a number of conventional surface mount (SMT) soldering processes including infrared (IR), convection heating, wave soldering, intrusive reflow and Ball Grid Array (BGA)

A combination of the above processes can be used whereby a soldered interface is introduced to terminate the metalized housing to the PWB with a spring member used to carry the shielding to the mating connector.

Although the previously described embodiments refer to the metallization of the ground lines, it is understood that the signal lines could also be metallized in the same fashion. As an example, one side wall of a housing could be metallized to connect electrically the signal contacts, while the other side of the housing could be metallized to connect the ground contacts. To ensure separation of the ground and signal lines, a spacer could be placed between adjacent sub-assemblies when inserted into the exterior housings.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. An electrical connector, comprising:
a housing;
signal contacts secured to said housing; and
ground contacts secured to said housing;
wherein a portion of said housing is metallized to connect said ground contacts electrically and to shield said signal contacts.

2. The connector as recited in claim 1, wherein said housing is overmolded to said ground contacts.

3. The connector as recited in claim 1, wherein said ground contacts are inserted into said housing.

4. The connector as recited in claim 1, wherein a portion of each of said ground contact is also metallized.

5. The connector as recited in claim 4, wherein said ground contacts each have a proximal end adjacent said housing and a distal end extending from said housing, and said proximal end of at least one of said ground contacts is wider than said distal end.

6. The connector as recited in claim 5, wherein said proximal end of said each ground contact is metallized.

7. The connector as recited in claim 1, wherein said housing has grooves therein, said grooves being metallized.

8. The connector as recited in claim 7, wherein said ground contacts extend from said housing adjacent said grooves.

9. A backplane receptacle connector, comprising:
an exterior housing; and
a plurality of sub-assemblies arranged within said exterior housing, each sub-assembly having:
a housing;
signal contacts secured to said housing; and
ground contacts secured to said housing;
wherein a portion of said housings are metallized to connect said ground contacts electrically and to shield said signal contacts.

10. The receptacle connector as recited in claim 9, wherein said signal contacts in said sub-assemblies are arranged in a single column.

11. The receptacle connector as recited in claim 9, wherein said signal contacts is said sub-assemblies are arranged in two adjacent columns.

12. The receptacle connector as recited in claim 9, wherein a portion of each of said ground contact is metallized.

13. The receptacle connector as recited in claim 12, wherein said ground contacts each have a proximal end adjacent said housing and a distal end extending from said housing, and said proximal end of at least one of said ground contacts is wider than said distal end.

14. The receptacle connector as recited in claim 13, wherein said proximal end of said each ground contact is metallized.

15. The receptacle connector as recited in claim 9, wherein said housings have grooves therein, said grooves being metallized.

16. The connector as recited in claim 7, wherein said ground contacts extend from said housing adjacent said grooves.

17. A method of shielding a connector, comprising the steps of:
providing a housing with contacts secured thereto; and
metallizing a portion of said housing to connect said contacts electrically.

18. The method as recited in claim 17, wherein said metallizing step comprises one of electrolytic plating, electroless plating, sputtering or vacuum metallization.

19. The method as recited in claim 17, wherein said housing has both signal and ground contacts, and said housing is metallized to connect at least said ground contacts electrically.

20. The method as recited in claim 17, wherein said housing includes grooves therein, and said metallizing step includes metallizing said grooves.
